(19) United States
(12) Patent Application Publication
(10) Pub. No.: US 2015/0357119 A1
(43) Pub. Date: Dec. 10, 2015

(54) MANUFACTURING METHODS OF A POWDER FOR RARE EARTH MAGNET AND THE RARE EARTH MAGNET BASED ON EVAPORATION TREATMENT

(71) Applicant: XIAMEN TUNGSTEN CO., LTD., Xiamen, Fujian (CN)

(72) Inventors: Hiroshi NAGATA, Xiamen, Fujian (CN); Chonghu WU, Xiamen, Fujian (CN)

(73) Assignee: XIAMEN TUNGSTEN CO., LTD., Xiamen, Fujian (CN)

(21) Appl. No.: 14/758,696

(22) PCT Filed: Dec. 31, 2013
(86) PCT No.: PCT/CN2013/091065

§ 371 Date: Jun. 30, 2015

(30) Foreign Application Priority Data
Dec. 31, 2012 (CN) 201210592348.5

(51) Int. Cl. H01F 41/02; C22C 38/10; C22C 38/06; C22C 38/04; H01F 1/057; C22C 1/04; B22F 9/04; C22C 38/12; H01F 1/055; C22C 38/16; C22C 38/00

(52) U.S. Cl. CPC H01F 41/0293; C22C 38/16; C22C 38/10; C22C 38/06; C22C 38/04; C22C 38/007; C22C 38/005; C22C 38/004; C22C 38/002; C22C 1/04; B22F 9/04; C22C 38/12; H01F 1/0557; H01F 1/057

(57) ABSTRACT

A manufacturing method of a powder for rare earth magnet and the rare earth magnet based on evaporation treatment, includes the steps of: coarsely crushing an alloy for the rare earth magnet and then finely crushing to obtain a fine powder; and evaporating the fine powder and an evaporation material in vacuum or in inert gas atmosphere; wherein the weight ratio of the evaporation material evaporated to the fine powder and the fine powder is 10-6˜0.05:1. By adding the process of evaporation treatment of fine powder before the process of compacting under a magnetic field and after the process of fine crushing, the sintering property of the powder is changed drastically; a magnet with a high coercivity, a high squareness and a high heat resistance is obtained.

### FIELD OF THE INVENTION

The present invention relates to magnet manufacturing technique field, especially to manufacturing methods of a powder for rare earth magnet and the rare earth magnet based on evaporation treatment

### BACKGROUND OF THE INVENTION

Rare earth magnet is based on intermetallic compound R₂T₁₄B, thereinto, R is rare earth element, T is iron or transition metal element replacing iron or part of iron, B is boron, Rare earth magnet is called the king of the magnet as its excellent magnetic properties, the maximum magnetic energy product (BH)max is ten times higher than that of the ferrite magnet (Ferrite), besides, the maximum operation temperature of the rare earth magnet may reach 200° C., which has an excellent machining property, a hard quality, a stable performance, a high cost performance and a wide applicability.

There are two types of rare earth magnets depending on the manufacturing method: one is sintered magnet and the other one is bonded magnet. The sintered magnet of which has wider applications. In the conventional technique, the process of sintering the rare earth magnet is mainly performed as follows: raw material preparing→melting→casting→hydrogen decrepitation (HD)→jet milling (JM)→compacting under a magnetic field→sintering→heat treatment→magnetic property evaluation→oxygen content evaluation of the sintered magnet.

The development history of the sintered rare earth magnet cannot be overly summarized in a word that it is the developing of improving the content rate of the main phase and reducing the constitute of the rare earth. Recently, to improve (BH)max and coercivity, the integral anti-oxidization technique of the manufacturing method is developing continuously, so the oxygen content of the sintered magnet can be reduced to below 2500 ppm at present; however, if the oxygen content of the sintered magnet is too low, the affects of some unstable factors like micro-constituent fluctuation or infiltration of impurity during the process is amplified, so that it results in over sintering and abnormal grain growth (AGG), low coercivity, low squareness and low heat resistance property and so on.

To improve the coercivity and squareness of the magnet and solve the problem of low heat resistance problem, it is common to perform grain boundary diffusion with the heavy rare earth elements such as Dy, Tb, Ho and so on to the sintered Nd—Fe—B magnet, the grain boundary diffusion is generally performed after the machining process before the surface treatment process. The grain boundary diffusion method is a method of diffusing Dy, Tb and other heavy rare earth elements diffused in the grain boundary of the sintered magnet, the method comprises the steps in accordance with 1) to 3):

1) coating the rare earth fluoride (DyF₃, TbF₃), rare earth oxide (Dy₂O₃, Tb₂O₃) and other powder on the surface of the sintered magnet, then performing grain boundary diffusion of the elements Dy, Tb to the magnet at a temperature of 700° C.˜900° C.;

2) coating method of rich heavy rare earth alloy powder: coating DyH₂ powder, TbH₂ powder, (Dy or Tb)—Co—No—Al metallic compound powder, then performing the grain boundary diffusion of DY, Tb and other elements to the magnet at a temperature of 700° C.˜900° C.;

3) evaporation method: using high temperature evaporation source to generate Dy, Tb and other heavy rare earth metal vapor, then performing grain boundary diffusion of DY, Tb and other elements to the magnet at a temperature of 700° C.˜900° C.

By the grain boundary diffusion method, the values of Br, (BH)max of the magnet remain unchanged essentially, the value of coercivity is increased to about 7 kOe, and the value of the heat resistance of the magnet is raised about 40° C.

The above mentioned method performs grain boundary diffusion under the temperature condition of 700° C.˜900° C., although the value of coercivity is increased, there are still some problems:

1. the diffusion takes a long time, for example, it may take 48 hours for diffusing the heavy rare earth element to the center of a magnet with a thickness of 10 mm, however, it may not ensure 48 hours of diffusion time in mass production because it has to increase the manufacturing efficiency by shortening the diffusion time; therefore, the heavy rare earth element (Dy, Tb, Ho or other elements) may not be sufficiently diffused to the center of the magnet, and the heat resistance of the magnet may not be sufficiently increased;

2. the magnet may react with the placement and the rule, therefore the surface of the magnet material would be scratched, and the cost of the rule consumption is high;

3. the magnet may have a low oxygen content, consequently the oxidation may not be evenly distributed through the inside and outside of the magnet, so that the oxidation film may not be evenly diffused, and the magnet may easily deform (bend) after the RH diffusion.

### SUMMARY OF THE INVENTION

The present invention overcomes the disadvantages of the conventional technique and provides a manufacturing method of a powder for rare earth magnet based on an evaporation treatment, the evaporation treatment of fine powder is performed before the process of compacting under a magnetic field and after the process of fine powder evaporation treatment, so that the sintering property of the powder is changed drastically, and it is capable of obtaining a magnet with a high coercivity, a high squareness and a high heat resistance.

The technical proposal of the present invention to solve the technical problem is that:

A manufacturing method of a powder for rare earth magnet based on evaporation treatment, the rare earth magnet comprises R₂T₁₄B main phase, R is selected from at least one rare earth element including yttrium, and T is at least one transition metal element including the element Fe; the method comprising the steps of: coarsely crushing an alloy for the rare earth magnet and then finely crushing to obtain a fine powder; and evaporating the fine powder and an evaporation material in vacuum or in inert gas atmosphere, wherein

the weight ratio of the evaporation material evaporated to the fine powder and the fine powder is 10⁻⁶˜0.05:1, and

the evaporation material is selected from at least one material including Yb, Eu, Ba, Sm, Tm, Dy, Nd, Gd, Er, Pr, Tb, Ho, K, Na, Sr, Tl, Mn, Sn, Sb, P, Zn, Mg, Li, Ca, Ga, Ag, Al, Cu, B₂O₃, MoO₃, ZnS, SiO and WO₃.

By adding the process of the heat evaporation treatment, the present invention can solve the technical problems, the reason is that, with the heat evaporation treatment, it has the following effects:

1) tiny amounts of evaporation layer is generated on the surface of the powder, so the new surface of the powder due to crushing is no longer remained;

2) the scratch on the surface of the alloy powder is removed by the hardening effect, so that it avoids the loss of sintering promotion effect due to the defect or other facts.

3) the sharp edge on the surface of the alloy powder is melted and becomes round, thus it reduces the contact area of the fine powder, the lubricating property of the powder is better, the lattice defect of surface of the powder is recovered, and therefore the orientation degree of the powder and the coercivity of the magnet are improved;

4) the even evaporation layer builds a favorable condition for evenly sintering.

With above factors and combined, the property of the powder is changed drastically, so that it can obtain a magnet with a high coercivity, a high squareness and a high heat resistance.

In another preferred embodiment, the oxygen content of the rare earth magnet is below 1500 ppm. Oxidant hardly happens in the compacting and sintering processes with the integral anti-oxidation level of the manufacturing method. Thus the oxygen content of the magnet is mainly affected by the jet milling process in the large amount of airflow. High performance of sintered magnet with an oxygen content reducing to below 2500 ppm can be obtained when the oxygen content of the atmosphere in the jet milling process is reduced to lower than 1000 ppm. However, if the oxygen content of the magnet is below 2500 ppm, the adhesive power among the magnet powder may be too strong, resulting in low orientation degree of the powder; and as the content of the oxide is reduced, it is easily to cause the problem of over sintering, and more easily to cause the problem of abnormal grain growth, which leads to the reducing of the coercivity, squareness and heat resistance of the magnet. In contrast, by adopting the evaporation treatment of the fine powder, the present invention overcomes the above problems due to low oxygen content process, which is capable of obtaining high values of BR and (BH)max without affecting the coercivity of the magnet, squareness and heat resistance. It could be said that the evaporation treatment of the fine powder is the optimal method to manufacture a high performance magnet with a low oxygen content.

In another preferred embodiment, the fine powder is put into a coating chamber, the coating chamber is then pumped to be vacuum, the evaporation material is heated to above its evaporation temperature to evaporate the fine powder, the temperature of the coating chamber is in a range of 50° C.˜800° C., the evaporation time is between 6 minutes to 24 hours.

In another preferred embodiment, the temperature of the coating chamber is in a range of 300° C.˜700° C., that is to say, the evaporation material is preferred as a maternal with its evaporation temperature in the above mentioned temperature range under a certain pressure.

In another preferred embodiment, the alloy for the rare earth magnet is obtained by strip casting an molten alloy fluid of raw material and being cooled at a cooling rate between 10²° C./s to 10⁴° C./s.

In another preferred embodiment, the coarse crushing process comprises a step of hydrogen decrepitating the alloy for the rare earth magnet under a hydrogen pressure between 0.01 MPa to 1 MPa for 0.5˜6 hours and a step of dehydrogenating; the fine crushing is treated by jet milling.

In another preferred embodiment, in the evaporation treatment process, the fine powder is vibrated or shaken. In the evaporation treatment of fine powder process, to prevent adhesion and condensation between the powder, a rotating furnace is preferably used to improve the manufacturing efficiency.

In another preferred embodiment, the fine power is evaporated under a pressure between 10⁻⁵ Pa to 1000 Pa in vacuum or under a pressure between 10⁻³ Pa and 1000 Pa in inert gas atmosphere. The present invention only takes evaporation treatment of the fine powder in vacuum for example, but it is also suitable in the inert gas atmosphere. In the present invention, as the vacuum pressure is configured as below 1000 Pa, which is much lower than the standard atmospheric pressure; according to the mean free path formula, the mean free path of the oxidizing gas is inversely proportional to the pressure P, therefore it raises the probability of evenly evaporating a single powder, all of the top layer, the central layer and the bottom layer of the powder could be evenly treated by the evaporation treatment, thus obtaining a high performance powder.

In another preferred embodiment, counted in atomic percent, the component of the alloy is RₑT_{f}A_{g}JₕGᵢDₖ, wherein

R is Nd or comprising Nd and selected from at least one of the elements La, Ce, Pr, Sm, Gd, Dy, Tb, Ho, Er, Eu, Tm, Lu and Y; T is Fe or comprising Fe and selected from at least one of the elements Ru, Co and Ni; A is B or comprising B and selected from at least one of the elements C or P; J is selected from at least one of the elements Cu, Mn, Si and Cr; G is selected from at least one of the elements Al, Ga, Ag, Bi and Sn; D is selected from at least one of the elements Zr, Hf, V, Mo, W, Ti and Nb; and counted in atomic percent, the subscripts are configured as:

the atomic percent of e is 12≦e≦16,

the atomic percent of g is 5≦g≦9,

the atomic percent of h is 0.05≦h≦1,

the atomic percent of i is 0.2≦i≦2.0,

the atomic percent of k is k is 0≦k≦4,

the atomic percent of f is f=100−e−g−h−i−k.

The present invention further provides a manufacturing method of rare earth magnet.

A manufacturing method of a rare earth magnet, the rare earth magnet comprises R₂T₁₄B main phase, R is selected from at least one rare earth element including yttrium, and T is at least one transition metal element including the element Fe; the method comprising the steps of: coarsely crushing an alloy for the rare earth magnet and then finely crushing to obtain a fine powder; evaporating the fine powder and an evaporation material in vacuum or in inert gas atmosphere; compacting the fine powder under a magnetic field as a green compact; and sintering the green compact in vacuum or in inert gas atmosphere at a temperature of 900° C.˜1140° C.; wherein the weight ratio of the evaporation material evaporated to the fine powder and the fine powder is 10⁻⁶˜0.05:1, and the evaporation material is selected from at least one material including Yb, Eu, Ba, Sm, Tm, Dy, Nd, Gd, Er, Pr, Tb, Ho, K, Na, Sr, Tl, Mn, Sn, Sb, P, Zn, Mg, Li, Ca, Ga, Ag, Al, Cu, B₂O₃, MoO₃, ZnS, SiO and WO₃.

In another preferred embodiment, further comprising a process of RH (heavy rare earth element) grain boundary diffusion at a temperature of 700° C.˜1050° C. after the sintering process.

Preferably, the temperature of the grain boundary diffusion is 1000° C.˜1050° C.

Compared to the conventional technique, the present invention has advantages as follows:

1) the finely crushed fine powder and the evaporation material are put into a treating container, by moving the container like rotating, stirring or shaking, the evaporation material can be evenly evaporated and coated on the surface of the fine powder, so the property of the powder is changed drastically, thus manufacturing a magnet with a high coercivity, a high squareness and a high heat resistance;

2) compared to the conventional technique, the powder can be sintered at a relatively temperature that is 20˜60° C. higher than before, or at a temperature 20˜60° C. lower than before, at any temperature, the phenomenon of abnormal grain growth (AGG) would not happen, so that the powder with evaporation treatment can be sintered in an extremely wide sintering temperature range, and the manufacturing condition is expanded.

3) the sintered magnet can be manufactured to a desired size to perform grain boundary diffusion; in the present invention, the grain boundary diffusion experiments are conducted at temperature of 700° C.˜1080° C., it is capable of subverting the common sense and accomplishing the grain boundary diffusion treatment in a short time at the temperature higher than 900° C. by using this kind of magnet; thus diminishing the disadvantage of time consuming of conventional method for grain boundary diffusion. Furthermore, the temperature range of 1000° C.˜1050° C. is configured as the most appropriate for the RH grain boundary diffusion; therefore, it is capable of solving the time consuming problem of the conventional method for grain boundary diffusion by adopting a diffusion temperature higher than the conventional technique when the time schedule is tense.

4) by adopting the fine powder evaporation treatment of the present invention, an evaporation layer is evenly distributed on the surface of the powder, therefore it is capable of performing mass production of non-bending magnet;

5) it doesn't need to attach to the rule during the diffusion, thus avoiding defective scratches on the surface of the magnet material.

### DETAILED DESCRIPTION OF THE EMBODIMENTS

The present invention will be further described with the embodiments.

### Embodiment 1

Raw material preparing process: Nd, Pr, Dy, Tb and Gd with 99.5% purity, industrial Fe—B, industrial pure Fe, Co with 99.9% purity and Cu, Mn, Al, Ag, Mo and C with 99.5% purity are prepared. Counted in atomic percent, and prepared in RₑT_{f}A_{g}JₕGᵢDₖ components. The contents of the elements are shown in TABLE 1:

TABLE 1
proportioning of each element

| R | | | | | T | | A | | J | | G | | D |
|---|---|---|---|---|---|---|---|---|---|---|---|---|---|
| Nd | Pr | Dy | Tb | Gd | Fe | Co | C | B | Cu | Mn | Al | Ag | Mo |
| 8 | 4 | 0.5 | 0.5 | 0.5 | remain- | 1 | 0.05 | 6.5 | 0.1 | 0.1 | 0.3 | 0.1 | 0.5 |
| | | | | | der | | | | | | | | |

Preparing 500 Kg raw material by weighing in accordance with TABLE 1.

Melting process: the 500 Kg raw material is put into an aluminum oxide made crucible, an intermediate frequency vacuum induction melting furnace is used to melt the raw material in a vacuum below 10 Pa below 1500° C.

Casting process: After the process of vacuum melting, Ar gas is filled to the melting furnace so that the Ar pressure would reach 30000 Pa, then the material is casted as a strip with an average thickness of 0.2 mm by strip casting method.

Hydrogen decrepitation process: the alloy is put into the stainless steel container of a rotating hydrogen decrepitation furnace with an inner diameter of φ1200 mm, the container is then pumped to be vacuum and the vacuum level is below 10 Pa, then hydrogen of 99.999% purity is filled into the container, the hydrogen pressure would reach 0.12 MPa, the container rotates for 2 hours at a rotating rate of 1 rpm to absorb hydrogen, after that, the container is heated and pumped for 2 hours at 600° C. in vacuum, then the container rotates and gets cooled at a rotating rate of 30 rpm, the coarse powder is then taken out.

Fine crushing process: a jet milling device is used to finely crush the coarse powder to obtain a fine powder with an average particle size of 2.0 nm.

The fine powder with jet milled is divided into 27 equal parts, each part has 15 Kg.

Heat evaporation treatment of the fine powder process: each part of the fine powder is respectively put into a stainless steel container (coating chamber) with an inner diameter of φ600 mm, the container is pumped to be vacuum, and then put to an externally heating oven, according to TABLE 2, 10 g of evaporation material of experiment No. 1˜27 is respectively put into an independent evaporation room, each of the evaporation room is pumped to same vacuum level as the coating chamber, being heated to above the evaporation temperature, then the vapor of the evaporation material is respectively guided to the stainless steel container (coating chamber) to evaporate each of the fine powder for 2 hours, when heating, the stainless steel container rotates at a rotating rate of 2 rpm; the evaporation material evaporates due to heat, so that the vacuum level is changed, and a molecular pump is used to control the change of the suction for controlling the vacuum level in the range of TABLE 2. It has to be noted that, in this embodiment 1, except the embodiments using materials K, P and Rb, the temperature of the coating chamber is controlled to a temperature of 200° C. lower than the evaporation temperature of the evaporation material; in K, Rb embodiment, the temperature of the coating chamber is 50° C. lower than the evaporation temperature, in P embodiment, the temperature of the coating chamber is 100° C. lower than the evaporation temperature.

After the heat evaporation treatment, the container is taken out of the container, the container is then externally water cooled at a rotating rate of 20 rpm for 1 hours.

The evaporation materials of experiment No. 1˜27 are respectively used with a plurality of blocky evaporation materials of 0.5˜2 cm³, then the fine powder after evaporation treatment is taken out, and a screen is used to separate the evaporation material and the fine powder.

Compacting process under a magnetic field: no organic additive such as forming aid or lubricant is added into all the fine powder, a transversed type magnetic field molder is used, the powder is compacted in once to form a cube with sides of 40 mm in an orientation field of 2.1 T and under a compacting pressure of 0.2 ton/cm², then the once-forming cube is demagnetized in a 0.2 T magnetic field. The once-forming compact (green compact) is sealed so as not to expose to air, the compact is secondary compacted by a secondary compact machine (isostatic pressing compacting machine) under a pressure of 1.2 ton/cm².

Sintering process: each of the green compact is moved to the sintering furnace, firstly sintering in a vacuum of 10⁻² Pa and respectively maintained for 2 hours at 300° C. and for 2 hours at 800° C., then in Ar gas atmosphere of 20000 Pa, sintering for 2 hours at 1080° C., after that filling Ar gas into the sintering furnace so that the Ar pressure would reach 0.1 MPa, then cooling it to room temperature.

Heat treatment process: the sintered magnet is heated for 2 hour at 450° C. in the atmosphere of high purity Ar gas, then cooling it to room temperature and taking it out.

Magnetic property evaluation process: the sintered magnet is tested by NIM-10000H type nondestructive testing system for BH large rare earth permanent magnet from China Jiliang University.

Oxygen content of sintered magnet evaluation process: the oxygen content of the sintered magnet is measured by EMGA-620W type oxygen and nitrogen analyzer from HORIBA company of Japan.

The magnetic property and oxygen content evaluation of the embodiments and the comparing samples with heat evaporation treatment with different evaporation materials are shown in TABLE 2:

TABLE 2
The magnetic property and oxygen content evaluation of the embodiments and the comparing samples

| | | | Vacuum | Evapo- | | | | | Oxygen |
|---|---|---|---|---|---|---|---|---|---|
| | | Evapo- | level of | ration | | | | | content of |
| | | ration | the con- | tempera- | Br | Hcj | SQ | (BH)max | the sintered |
| No. | | material | tainer (Pa) | ture(° C.) | (kGs) | (k0e) | (%) | (MG0e) | magnet (ppm) |
| 0 | Comparing | Non heat evaporation | | | 14.2 | 11.4 | 79.8 | 45.6 | 2630 |
| | sample | treatment of fine powder | | | | | | | |
| 1 | Embodiment | WO₃ | 0.05~0.00001 | 900 | 14.8 | 17.3 | 98.3 | 52.3 | 375 |
| 2 | Embodiment | B₂O₃ | | 800 | 14.8 | 15.6 | 98.2 | 52.8 | 379 |
| 3 | Embodiment | SiO | | 1000 | 14.8 | 15.7 | 99.1 | 52.1 | 371 |
| 4 | Embodiment | ZnS | | 700 | 14.6 | 14.8 | 99.1 | 50.1 | 369 |
| 5 | Embodiment | Cu | | 900 | 14.8 | 17.2 | 99.2 | 53.2 | 383 |
| 6 | Embodiment | Al | | 800 | 14.8 | 17.6 | 98.5 | 52.8 | 369 |
| 7 | Embodiment | Ga | | 700 | 14.8 | 17.3 | 98.3 | 53.1 | 375 |
| 8 | Embodiment | Ag | | 600 | 14.8 | 17.6 | 98.5 | 52.8 | 385 |
| 9 | Embodiment | Mn | | 700 | 14.7 | 16.1 | 98.7 | 51.8 | 376 |
| 10 | Embodiment | Er | | 800 | 14.6 | 15.4 | 98.2 | 51.3 | 381 |
| 11 | Embodiment | Ho | | 800 | 14.7 | 16.3 | 99.1 | 52.3 | 375 |
| 12 | Embodiment | Dy | | 700 | 14.7 | 16.8 | 99.1 | 52.3 | 369 |
| 13 | Embodiment | Sm | | 500 | 14.6 | 15.2 | 99.2 | 50.3 | 385 |
| 14 | Embodiment | MoO₃ | 0.05~1000 | 600 | 14.8 | 17.5 | 99.2 | 53.2 | 328 |
| 15 | Embodiment | Zn | | 400 | 14.7 | 16.3 | 98.7 | 52.3 | 375 |
| 16 | Embodiment | P | | 200 | 14.6 | 15.6 | 98.2 | 51.5 | 376 |
| 17 | Embodiment | Te | | 400 | 14.6 | 15.3 | 98.7 | 50.6 | 371 |
| 18 | Embodiment | Na | | 300 | 14.6 | 14.6 | 98.5 | 50.4 | 368 |
| 19 | Embodiment | Mg | | 300 | 14.7 | 16.8 | 99.3 | 52.5 | 382 |
| 20 | Embodiment | K | | 100 | 14.6 | 16.2 | 98.4 | 50.9 | 385 |
| 21 | Embodiment | Rb | | 100 | 14.6 | 16.9 | 98.3 | 51.3 | 375 |
| 22 | Embodiment | Sr | | 400 | 14.7 | 16.7 | 98.9 | 51.8 | 379 |
| 23 | Embodiment | Ba | | 500 | 14.7 | 16.1 | 98.2 | 51.5 | 384 |
| 24 | Embodiment | Ca | | 500 | 14.6 | 16.8 | 98.7 | 51.3 | 367 |
| 25 | Embodiment | Li | | 500 | 14.6 | 16.7 | 98.5 | 50.6 | 372 |
| 26 | Embodiment | Eu | | 500 | 14.7 | 15.2 | 98.6 | 50.3 | 389 |
| 27 | Embodiment | Yb | | 600 | 14.7 | 15.8 | 98.7 | 50.9 | 383 |

As can be seen from TABLE 2, with the heat evaporation treatment of the fine powder, a very thin evaporation coating film is coated on the surface of the powder evenly, so that the lubricity is well among the powder, and the orientation degree of the powder is improved, so that it can obtain higher values of Br and (BH)max; furthermore, the phenomenon of abnormal grain growth would not happen when sintering, so that it can obtain a finer organization, and the value of coercivity Hcj is increased drastically; in addition, by the heat evaporation treatment of the fine powder, the sharp portion on the surface of the powder is evaporation coated, partially molted and becomes round; moreover, the counter magnetic field coefficient at the partial portion is reduced due to the coated magnetic insulation film, therefore a higher coercivity is obtained. Furthermore, during the processes from compacting to sintering, the powder with even an evaporation film on the surface is weakened in activity, so during those processes, even the powder is contacted with the air, drastic oxidation would not happen; on the contrary, the fine powder without heat treatment has a strong activity and is easily oxidized, during the processes from compacting to sintering, even contacted with a little amount of air, drastic oxidation would happen, leading to a higher oxygen content of the sintered magnet.

It has to be noted that, if the evaporation temperature of the fine powder exceeds 800° C., the evaporation coating film on the surface of the fine powder particle may be easily diffused into the inner of the particle, consequently it would be like no evaporation coating film, therefore the activity of the surface of the powder is strong, and the adhesive power among the powder gets stronger, in this case, the values of Br and (BH)max would be extremely adverse, meanwhile losing the effect of avoiding the abnormal grain growth, so that the phenomenon of abnormal grain growth (AGG) would easily happen when sintering, and the value of coercivity Hcj is reduced.

In the past, in the low oxygen content process, as the adhesive power among the magnet powder is strong, and the orientation degree of the magnet powder is not too high, so that it also has problems of low values of Br and (BH)max; moreover, as the surface activity among the magnet powder is strong, the grains are easily welded when sintering, therefore the phenomenon of abnormal grain growth (AGG) happens, and the value of coercivity is reduced drastically. The above mentioned problems are solved by adopting the proposal of the present invention.

### Embodiment 2

Raw material preparing process: Nd, Lu with 99.9% purity, industrial Fe—B, industrial pure Fe—P, industrial pure Fe, Ru, Cu, Mn, Ga with 99.9% purity, and Zr with 99.5% purity are prepared.

Counted in atomic percent, and prepared in RₑT_{f}A_{g}JₕGᵢDₖ components.

The contents of the elements are shown in TABLE 3:

TABLE 3
proportioning of each element

| R | | T | | A | | J | | G | D |
|---|---|---|---|---|---|---|---|---|---|
| Nd | Lu | Fe | Ru | B | P | Cu | Mn | Ga | Zr |
| 12.6 | 0.1 | remain- | 0.1 | 5.9 | 0.05 | 0.2 | 0.1 | 0.1 | 0.01 |
| | | der | | | | | | | |

Preparing 100 Kg raw material by weighing in accordance with TABLE 3.

Melting process: the 100 Kg raw material is put into an aluminum oxide made crucible, an intermediate frequency vacuum induction melting furnace is used to melt the raw material in 10⁻² Pa vacuum below 1650° C.

Casting process: After the process of vacuum melting, Ar gas is filled to the melting furnace so that the Ar pressure would reach 20000 Pa after vacuum melting, then the material is casted as a strip with an average thickness of 3 mm on a water-cooling casting disk.

Hydrogen decrepitation process: the strip is put into a stainless steel container of a rotating hydrogen decrepitation furnace with an inner diameter of φ800 mm, the container is then pumped to be vacuum and the vacuum level is below 10 Pa, then hydrogen of 99.999% purity is filled into the container, the hydrogen pressure would reach 0.08 MPa, the container rotates for 4 hours at a rotating rate of 2 rpm to absorb hydrogen, after that, the container is pumped for 3 hours at 500° C. in vacuum, then the container rotates and gets cooled at a rotating rate of 5 rpm, the cooled coarse powder is then taken out.

Fine crushing process: a jet milling device is used to finely crush the coarse powder to obtain a fine powder with an average particle size of 7.0 nm, then the powder is divided into 2 equal parts.

Heat evaporation treatment of the fine powder process: one part of the fine powder of 50 Kg after jet milling is put into a stainless steel container (coating chamber) with an inner diameter of φ800 mm, the container is pumped to be vacuum and the vacuum level is below 10⁻² Pa, and then put to an externally heating oven for heating, the heating temperature is 500° C., 1 Kg evaporation material (including a plurality of Cu balls with diameter of 5˜10 mm) is put into an independent evaporation room, the evaporation room is pumped to be vacuum and the vacuum level is below 10⁻² Pa, then it is heated to a temperature above 700° C., then the vapor of the evaporation material is guided to the stainless steel container (coating chamber) to evaporate the fine powder for 4 hours, when heating, the stainless steel container rotates at a rotating rate of 2 rpm.

After the heat evaporation treatment, the container is taken out of the furnace, the container is then externally water cooled at a rotating rate 20 rpm for 3 hours, then the fine powder after evaporation treatment is taken out, and a screen is used to separate the evaporation material and the fine powder.

Compacting process under a magnetic field: no organic additive such as forming aid or lubricant is added into the part of fine powder with the process of fine powder heat evaporation treatment and the rest part of the fine powder without the process of fine powder heat evaporation treatment, and a transversed type magnetic field molder is directly used, the two types of powder are respectively compacted in once to form a cube with sides of 30 mm in an orientation field of 2 T and under a compacting pressure of 0.2 ton/cm², then the once-forming cube is demagnetized in a 0.15 T magnetic field. The once-forming compact (green compact) is sealed so as not to expose to air, then the compact is secondary compacted by a secondary compact machine (isostatic pressing compacting machine) under a pressure of 1 ton/cm².

Sintering process: each of the green compact is moved to the sintering furnace, firstly sintering in a vacuum of 10⁻² Pa and respectively maintained for 2 hours at 300° C. and for 2 hours at 500° C., then sintering at 1050° C. for 6 hours, after that filling Ar gas into the sintering furnace so that the Ar pressure would reach 0.1 MPa, then cooling it to room temperature.

Heat treatment process: the sintered magnet is heated for 2 hours at 650° C. in the atmosphere of high purity Ar gas, then cooling it to room temperature and taking it out.

Machining process: the sintered magnet compacted by the fine powder without the process of fine powder heat evaporation treatment is machined to be a magnet with 415 mm diameter and 3 mm thickness, the 3 mm direction (along the direction of thickness) is the orientation direction of the magnetic field, the magnets are divided into 2 parts, one part of which is served as no grain boundary diffusion treatment and is tested its magnetic property (comparing sample 1), the other part is treated by Method A in TABLE 4 for grain boundary diffusion treatment after washed and surface cleaning (comparing sample 2).

The sintered magnet with the process of fine powder heat evaporation treatment is machined to be a magnet with 415 mm and 5 mm thickness, the 5 mm direction (along the direction of thickness) is the orientation direction of the magnetic field, the magnets are divided into 4 parts, one part of which is not treated with the grain boundary diffusion treatment and is tested its magnetic property (comparing sample 3)

Grain boundary diffusion process: the other 3 parts of sintered magnet with the process of fine powder heat evaporation treatment are respectively treated by the grain boundary diffusion treatment according to Method A, B, C in TABLE 4 after washed and surface cleaning.

TABLE 4

| | Grain boundary diffusion type | Detailed process |
|---|---|---|
| A | Dy oxide powder, Tb fluoride | Dy oxide and Tb fluoride are prepared in proportion of |
| | powder coating diffusion | 3:1 to make raw material to fully spray and coat on the |
| | method | magnet, the coated magnet is then dried, then in high |
| | | purity of Ar gas atmosphere, the magnet is treated with |
| | | heat and diffusion treatment at 700° C. for 24 hours. |
| B | (Dy,Tb)—Ni—Co—Al serial alloy | The Dy₃₀Tb₃₀Ni₅Co₂₅Al₁₀ alloy is finely crushed as fine |
| | fine powder coating diffusion | powder with an average grain particle size 20 μm to |
| | method | fully spray and coat on the magnet, the coated magnet is |
| | | then dried in high purity Ar gas atmosphere, and the |
| | | magnet is treated with heat and diffusion treatment at |
| | | 900° C. for 4 hours. |
| C | Ho, Mo metal vapor diffusion | The Ho metal plate, Mo screen and magnet are put into |
| | method | a vacuum heating furnace for vapor diffusion at 1000° C. |
| | | for 4 hours. |

Magnetic property evaluation process: the sintered magnet is tested by NIM-10000H type nondestructive testing system for BH large rare earth permanent magnet from China Jiliang University.

Oxygen content of sintered magnet evaluation process: the oxygen content of the sintered magnet is measured by EMGA-620W type oxygen and nitrogen analyzer from HORIBA company of Japan.

The magnetic property and oxygen content evaluation of the embodiments and the comparing samples with the processes of fine powder heat evaporation treatment and the grain boundary diffusion are shown in TABLE 5.

TABLE 5
The magnetic property and oxygen content evaluation
of the embodiments and the comparing samples

| | | heat evapo- | | | | | | Oxygen |
|---|---|---|---|---|---|---|---|---|
| | | ration treat- | Grain | | | | | content of |
| | | ment of the | boundary | Br | Hcj | SQ | (BH)max | the sintered |
| No. | | fine powder | diffusion | (kGs) | (k0e) | (%) | (MG0e) | magnet (ppm) |
| 0 | Comparing | no | no | 13 | 7.2 | 72.5 | 21.2 | 2890 |
| | sample 1 | | | | | | | |
| 1 | Comparing | no | A | 13.2 | 12.9 | 87.8 | 33.4 | 2740 |
| | sample 2 | | | | | | | |
| 2 | Comparing | yes | no | 15.4 | 9.8 | 86.4 | 47.2 | 289 |
| | sample 3 | | | | | | | |
| 3 | Embodiment | yes | A | 15.4 | 22.7 | 99.1 | 55.3 | 278 |
| 4 | Embodiment | yes | B | 15.5 | 22.3 | 99.1 | 56.4 | 273 |
| 5 | Embodiment | yes | C | 15.6 | 25.1 | 99.2 | 58.2 | 275 |

As can be seen from TABLE 5, with the heat evaporation treatment of the fine powder, the evaporation material is coated on the surface of the fine powder evenly, the evaporation material at the grain boundary of the sintered magnet is enriched, the composition of the grain boundary phase is changed obviously, during the grain boundary diffusion, the diffusion rate of Dy, Tb, Ho is accelerated and the diffusion efficiency is promoted, so that the coercivity is improved significantly.

Common sense says that it generally takes more than 10 hours for the grain boundary diffusion of a magnet with a thickness of 5 mm in a temperature range of 800° C.˜950° C. so as to obtain an improving effect of coercivity; raising the diffusion temperature is benefit to shorten the diffusion time, but it may leads to the problems of deformation, surface molten and AGG, and the diffusion is simultaneously performed in the grain boundary phase and the main phase, resulting in losing of magnet property. In contrast, the diffusion to the magnet of the present invention is performed in a temperature range of 1000° C.˜1200° C. and only needs 2 hours, which is capable of obtaining an improving coercivity effect and shortening the production cycle without arising the above mentioned problems.

### Embodiment 3

Raw material preparing process: La, Ce, Nd, Ho, and Er with 99.5% purity, industrial Fe—B, industrial pure Fe, Ru with 99.99% purity and P, Si, Cr, Bi, Sn, Ta with 99.5% purity are prepared; counted in atomic percent, and prepared in RₑT_{f}A_{g}JₕGᵢDₖ components.

The contents of the elements are shown as follows:

R component, La is 0.1, Ce is 0.1, Nd is 12.5, Ho is 0.2, and Er is 0.2;

T component, Fe is the remainder, and Ru is 1;

A component, P is 0.05, and B is 6.5;

J component, Si is 0.01, and Cr is 0.15;

G component, Bi is 0.1, and Sn is 0.1; and

D component, Ta is 0.5.

Preparing 500 Kg raw material by weighing in accordance with above contents of elements.

Melting process: the 500 Kg raw material is put into an aluminum oxide made crucible, an intermediate frequency vacuum induction melting furnace is used to melt the raw material in 0.1 Pa vacuum below 1550° C.

Casting process: After the process of vacuum melting, Ar gas is filled to the melting furnace so that the Ar pressure would reach 10000 Pa, then the material is casted as a strip with an average thickness of 0.1 mm by strip casting method (SC).

Hydrogen decrepitation process: the alloy is put into the stainless steel container of a rotating hydrogen decrepitation furnace with an inner diameter φ1200 mm, the container is then pumped to be vacuum below 10 Pa, then hydrogen of 99.999% purity is filled into the container, the hydrogen pressure would reach 0.08 MPa, the container rotates for 4 hours at a rotating rate of 3 rpm to absorb hydrogen, after that, the container is pumped for 2 hours at 600° C. in vacuum, then the container rotates and gets cooled at a rotating rate of 30 rpm simultaneously, the cooled coarse powder is then taken out.

Fine crushing process: a jet milling device is used to finely crush the coarse powder to obtain a fine powder with an average particle size of 5 nm. The fine powder after jet milling is divided into 7 equal parts.

Heat evaporation treatment of the fine powder process: each part of the fine powder and 1 g evaporation material (including a plurality of blocky Ga with particle size of 5˜10 mm) are put into a stainless steel container of a rotating hydrogen decrepitation furnace with an inner diameter of φ1200 mm, then the container is pumped to be vacuum and obtain a vacuum level of below 0.0001 Pa, after that, the stainless steel container is put into an externally heating oven for heating.

The heat temperature and time of the evaporation for each part of the fine powder are shown in TABLE 6, the stainless steel container rotates at a rotating rate of 3 rpm during heating.

After heating, the container is taken out of the furnace, the container is then externally water cooled at a rotating rate of 10 rpm for 3 hours.

The fine powder after evaporation treatment is taken out, then a screen is used to separate the evaporation material and the fine powder.

Compacting process under a magnetic field: no organic additive is added to the fine powder; a transversed type magnetic field molder is directly used, the powder is compacted in once to form a cube with sides of 40 mm in an orientation field of 2.1 T and under a compacting pressure of 1.1 ton/cm², then the once-forming cube is demagnetized in a 0.15 T magnetic field. The once-forming compact (green compact) is sealed so as not to expose to air, and then the green compact is delivered to a sintering furnace.

Sintering process: each of the green compact is moved to the sintering furnace, firstly sintering in a vacuum of 10⁻¹ Pa and respectively maintained for 4 hours at 100° C. and for 4 hours at 400° C., then in Ar gas atmosphere of 20000 Pa, sintering for 3 hours in 1040° C., after that filling Ar gas into the sintering furnace so that the Ar pressure would reach 0.1 MPa, then cooling it to room temperature.

Heat treatment process: the sintered magnet is heated for 1 hour at 600° C. in the atmosphere of high purity Ar gas, then cooling it to room temperature and taking it out.

Magnetic property evaluation process: the sintered magnet is tested by NIM-10000H type nondestructive testing system for BH large rare earth permanent magnet from China Jiliang University.

Oxygen content of sintered magnet evaluation process: the oxygen content of the sintered magnet is measured by EMGA-620W type oxygen and nitrogen analyzer from HORIBA company of Japan.

The magnetic property and oxygen content evaluation of the embodiments and the comparing samples at same heating temperature and different evaporation time are shown in TABLE 6.

TABLE 6
The magnetic property and oxygen content evaluation
of the embodiments and the comparing samples

| | | Evaporation | Evaporation | | | | | Oxygen |
|---|---|---|---|---|---|---|---|---|
| | | temperature | time | | | | | content of |
| | | of fine | of fine | Br | Hcj | SQ | (BH)max | the sintered |
| No. | | powder (° C.) | powder (hr) | (kGs) | (k0e) | (%) | (MG0e) | magnet (ppm) |
| 0 | Comparing | 700 | 0.05 | 13.9 | 9.1 | 79.9 | 44.7 | 2780 |
| | sample | | | | | | | |
| 1 | Embodiment | 700 | 0.1 | 15.3 | 13.4 | 98.1 | 55.1 | 725 |
| 2 | Embodiment | 700 | 1 | 15.4 | 14.3 | 98.3 | 55.2 | 368 |
| 3 | Embodiment | 700 | 4 | 15.4 | 14.4 | 99.3 | 55.7 | 385 |
| 4 | Embodiment | 700 | 12 | 15.5 | 13.9 | 99.2 | 56.5 | 402 |
| 5 | Embodiment | 700 | 24 | 15.3 | 13.6 | 99.1 | 55.8 | 569 |
| 6 | Comparing | 700 | 48 | 14.9 | 12.7 | 97.4 | 52.8 | 980 |
| | sample | | | | | | | |

As can be seen from TABLE 6, if the fine powder is evaporated for less than 0.1 hour, the effect of the heat evaporation treatment is not sufficient, resulting in that it would be like no oxidation film, the adhesive power among the powder gets stronger, in that case, the values of Br and (BH)max would be extremely adverse, the phenomenon of AGG would easily happen when sintering, the value of coercivity Hcj would be reduced. On the other hand, if the evaporation time of the fine powder exceeds 24 hours, the evaporation coating film on the surface of the fine powder particle would be absorbed and diffused into the particle, consequently it would be like no oxidation film, therefore the oxygen content is increased, in this case, the values of Br and (BH)max would be reduced, the phenomenon of AGG would easily happen when sintering, and the value of coercivity Hcj would be reduced.

### Embodiment 4

Raw material preparing process: Sm, Eu, Nd, Tm, and Y with 99.5% purity, industrial Fe—B, industrial pure Fe, Ni with 99.99% purity and C, Cu, Mn, Ga, In, Ti with 99.5% purity are prepared; counted in atomic percent, and prepared in RₑT_{f}A_{g}JₕGᵢDₖ components.

The contents of the elements are shown as follows:

R component, Sm is 0.1, Eu is 0.1, Nd is 12.5, Tm is 0.5, and Y is 0.1;

T component, Fe is the remainder, Ni is 0.2;

A component, C is 0.05, and B is 6.5;

J component, Cu is 0.2, and Mn is 0.1;

G component, Ga is 0.2, and In is 0.1; and

D component, Ti is 0.5.

Preparing 500 Kg raw material by weighing in accordance with above contents of elements.

Melting process: the 500 Kg raw material is put into an aluminum oxide made crucible, an intermediate frequency vacuum induction melting furnace is used to melt the raw material in 0.1 Pa vacuum below 1550° C.

Casting process: Ar gas is filled to the melting furnace so that the Ar pressure would reach 40000 Pa after the process of vacuum melting, then the material is casted as a strip with an average thickness of 0.6 mm by strip casting method (SC).

Hydrogen decrepitation process: the strip is put into a stainless steel container of a rotating hydrogen decrepitation furnace with an inner diameter of φ1200 mm, the container is then pumped to be vacuum and the vacuum level is below 10 Pa, then hydrogen of 99.999% purity is filled into the container, the hydrogen pressure would reach 0.1 MPa, the container rotates for 2 hours at a rotating rate of 2 rpm to absorb hydrogen, after that, the container is heated and pumped for 3 hours at 700° C. in vacuum, then the container rotates and gets cooled at a rotating rate of 5 rpm simultaneously, the cooled coarse powder is then taken out.

Fine crushing process: a He jet milling device is used to finely crush the powder to obtain a fine powder with an average particle size of 1.8 nm.

The fine powder is divided into two equal parts, each part has 250 Kg.

Heat evaporation treatment of the fine powder process: one part of the 250 Kg fine powder after jet milling and the 2 Kg evaporation material (including a plurality of silver particle of 2˜10 mm) are put into the stainless steel container of a rotating hydrogen decrepitation furnace with an inner diameter of φ1200 mm, then the container is pumped to be vacuum below 0.0001 Pa, after that, the stainless steel container is put into an externally heating oven for heating, the heating temperature is 600° C., the evaporation time is 2 hours, and the stainless steel container rotates at a rotating rate of 2 rpm during heating.

After the heating, the container is taken out of the externally heating oven, the container is then externally water cooled at a rotating rate 5 rpm for 5 hours.

The fine powder after heat evaporation treatment is taken out, then a screen is used to separate the evaporation material and the fine powder.

Compacting process under a magnetic field: no organic additive such as forming aid or lubricant is added into the above mentioned part of fine powder with the process of heat evaporation treatment and the rest one part of the fine powder without the process of heat evaporation treatment, a transversed type magnetic field molder is directly used, the powder is compacted in once to form a cube with sides of 40 mm in an orientation field of 1.8 T and under a compacting pressure of 1.1 ton/cm², then the once-forming cube is demagnetized in a 0.1 T magnetic field.

The once-forming compact (green compact) is sealed so as not to expose to air, and then the green compact is delivered to a sintering furnace.

Sintering process: each of the green compact is moved to the sintering furnace, firstly sintering in a vacuum of 10⁻² Pa and respectively maintained for 2 hours at 300° C. and for 2 hours at 700° C., then in Ar gas atmosphere of 50000 Pa, sintering at 900° C.˜1160° C. for 2 hours, after that filling Ar gas into the sintering furnace so that the Ar pressure would reach 0.1 MPa, then cooling it to room temperature.

Heat treatment process: the sintered magnet is heated for 1 hour in 600° C. in the atmosphere of high purity Ar gas, then cooling it to room temperature and taking it out.

Magnetic property evaluation process: the sintered magnet is tested by NIM-10000H type nondestructive testing system for BH large rare earth permanent magnet from China Jiliang University.

Oxygen content of sintered magnet evaluation process: the oxygen content of the sintered magnet is measured by EMGA-620W type oxygen and nitrogen analyzer from HORIBA company of Japan.

The magnetic property and oxygen content evaluation of the embodiments and the comparing samples with or without the process of fine powder evaporation treatment at different sintering temperature are shown in TABLE 7.

TABLE 7
The magnetic property and oxygen content evaluation of the embodiments and the comparing samples

| | | | | | | | | | Oxygen |
|---|---|---|---|---|---|---|---|---|---|
| | | | Sintering | | | | | | content of |
| | | Evaporation | temperature | Density | Br | Hcj | SQ | (BH)max | the sintered |
| No. | | treatment | (° C.) | (g/cc) | (kGs) | (k0e) | (%) | (MG0e) | magnet (ppm) |
| 1 | Comparing | no | 925 | 7.23 | 12.9 | 11.8 | 68.3 | 22.8 | 2670 |
| | sample | | | | | | | | |
| 2 | Comparing | no | 950 | 7.27 | 13.6 | 11.5 | 94.7 | 26.7 | 2860 |
| | sample | | | | | | | | |
| 3 | Comparing | no | 975 | 7.34 | 13.8 | 11.2 | 96.2 | 43.4 | 2790 |
| | sample | | | | | | | | |
| 4 | Comparing | no | 1000 | 7.45 | 14.1 | 10.9 | 96.1 | 44.2 | 2850 |
| | sample | | | | | | | | |
| 5 | Comparing | no | 1025 | 7.51 | 14.3 | 10.8 | 96.1 | 44.8 | 2750 |
| | sample | | | | | | | | |
| 6 | Comparing | no | 1050 | 7.54 | 13.8 | 10.5 | 92.5 | 40.7 | 2820 |
| | sample | | | | | | | | |
| 7 | Comparing | no | 1075 | 7.46 | 13.6 | 10.3 | 90.2 | 40.2 | 2840 |
| 8 | Comparing | no | 1100 | 7.42 | 13.2 | 10.1 | 88.5 | 39.5 | 2760 |
| | sample | | | | | | | | |
| 9 | Comparing | no | 1125 | 7.38 | 12.8 | 9.1 | 83.9 | 38.3 | 2850 |
| | sample | | | | | | | | |
| 10 | Comparing | no | 1140 | 7.32 | 12.1 | 8.2 | 81.7 | 30.1 | 2820 |
| | sample | | | | | | | | |
| 11 | Comparing | no | 1150 | 7.31 | 11.7 | 6.7 | 70.3 | 27.2 | 2840 |
| | sample | | | | | | | | |
| 12 | Embodiment | yes | 900 | 7.46 | 14.2 | 13.0 | 98.2 | 49.8 | 395 |
| 13 | Embodiment | yes | 950 | 7.48 | 14.4 | 13.2 | 98.2 | 50.6 | 421 |
| 14 | Embodiment | yes | 975 | 7.5 | 14.5 | 13.1 | 98.2 | 50.8 | 434 |
| 15 | Embodiment | yes | 1000 | 7.51 | 14.6 | 13 | 98.3 | 51.1 | 436 |
| 16 | Embodiment | yes | 1025 | 7.53 | 14.7 | 12.9 | 98.4 | 51.2 | 428 |
| 17 | Embodiment | yes | 1050 | 7.56 | 14.8 | 12.8 | 98.4 | 51.2 | 448 |
| 18 | Embodiment | yes | 1075 | 7.57 | 14.8 | 12.8 | 98.6 | 51.8 | 444 |
| 19 | Embodiment | yes | 1100 | 7.62 | 14.9 | 12.7 | 98.7 | 52.2 | 472 |
| 20 | Embodiment | yes | 1125 | 7.65 | 15 | 12.4 | 99.1 | 52.6 | 469 |
| 21 | Embodiment | yes | 1140 | 7.65 | 15 | 12.1 | 99.2 | 52.8 | 462 |
| 22 | Comparing | yes | 1150 | 7.29 | 13.4 | 11.8 | 76.5 | 32.6 | 896 |
| | sample | | | | | | | | |

As can be seen from TABLE 7, with heat evaporation treatment of the fine powder, it can significantly expand the sintering temperature range to obtain a high performance magnet. This because the evaporation film is capable of avoiding oxidation, which is beneficial for sintering at a low sintering temperature, and the phenomenon of abnormal grain growth would not happen. Therefore it is capable of obtaining a magnet with high property whether at low sintering temperature or at high sintering temperature.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A manufacturing method of a powder for rare earth magnet based on heat evaporation treatment, the rare earth magnet comprises R₂T₁₄B main phase, R is selected from at least one rare earth element including yttrium, and T is at least one transition metal element including the element Fe; the method comprising the steps of:
coarsely crushing an alloy for the rare earth magnet and then finely crushing to obtain a fine powder; and
evaporating the fine powder and an evaporation material in vacuum or in inert gas atmosphere, wherein
the weight ratio of the evaporation material evaporated to the fine powder and the fine powder is 10⁻⁶˜0.05:1, and
the evaporation material is selected from at least one material including Yb, Eu, Ba, Sm, Tm, Dy, Nd, Gd, Er, Pr, Tb, Ho, K, Na, Sr, Tl, Mn, Sn, Sb, P, Zn, Mg, Li, Ca, Ga, Ag, Al, Cu, B₂O₃, MoO₃, ZnS, SiO and WO₃.

2. The manufacturing method according to claim 1, wherein the oxygen content of the rare earth magnet is below 1500 ppm.

3. The manufacturing method according to claim 2, wherein the fine powder is put into a coating chamber, the coating chamber is then pumped to be vacuum, the evaporation material is heated to above its evaporation temperature to evaporate the fine powder, the temperature of the coating chamber is in a range of 50° C.˜800° C., the evaporation time is between 6 minutes to 24 hours.

4. The manufacturing method according to claim 3, wherein the temperature of the coating chamber is in a range of 300° C.˜700° C.

5. The manufacturing method according to claim 2, wherein the coarse crushing process comprises a step of hydrogen decrepitating under a hydrogen pressure between 0.01 MPa to 1 MPa for 0.5˜6 hours and a step of dehydrogenating; the fine crushing is treated by jet milling.

6. The manufacturing method according to claim 3, wherein in the evaporation treatment process, the fine powder is vibrated or shaken.

7. The manufacturing method according to claim 6, wherein the fine power is evaporated under a pressure between 10⁻⁵ Pa to 1000 Pa in vacuum.

8. The manufacturing method according to claim 2, wherein the fine powder is put into the coating chamber, the evaporation material is heated to above its evaporation temperature to evaporate the fine powder, the temperature of the coating chamber is in a range of 50° C.˜800° C., the evaporation time is between 6 minutes to 24 hours, the fine powder is evaporated under a pressure between 10⁻³ Pa to 1000 Pa in inert gas atmosphere.

9. The manufacturing method according to claim 7, wherein counted in atomic percent, the component of the alloy is RₑT_{f}A_{g}JₕGᵢDₖ, R is Nd or comprising Nd and selected from at least one of the elements La, Ce, Pr, Sm, Gd, Dy, Tb, Ho, Er, Eu, Tm, Lu and Y; T is Fe or comprising Fe and selected from at least one of the elements Ru, Co and Ni; A is B or comprising B and selected from at least one of the elements C or P; J is selected from at least one of the elements Cu, Mn, Si and Cr; G is selected from at least one of the elements Al, Ga, Ag, Bi and Sn; D is selected from at least one of the elements Zr, Hf, V, Mo, W, Ti and Nb; and counted in atomic percent, the subscripts are configured as:
the atomic percent at % of e is 12≦e≦16,
the atomic percent at % of g is 5≦g≦9,
the atomic percent at % of h is 0.05≦h≦1,
the atomic percent at % of i is 0.2≦i≦2.0,
the atomic percent at % of k is k is 0≦k≦4,
the atomic percent at % of f is f=100−e−g−h−i−k.

10. A manufacturing method of a rare earth magnet, the rare earth magnet comprises R₂T₁₄B main phase, R is selected from at least one rare earth element including yttrium, and T is at least one transition metal element including the element Fe; the method comprising the steps of:
coarsely crushing an alloy for the rare earth magnet and then finely crushing to obtain a fine powder;
evaporating the fine powder and an evaporation material in vacuum or in inert gas atmosphere;
compacting the fine powder is under a magnetic field as a green compact; and
sintering the green compact in vacuum or in inert gas atmosphere at a temperature of 900° C.˜1140° C.;
wherein the weight ratio of the evaporation material evaporated to the fine powder and the fine powder is 10⁻⁶˜0.05:1; and the evaporation material is selected from at least one material including Yb, Eu, Ba, Sm, Tm, Dy, Nd, Gd, Er, Pr, Tb, Ho, K, Na, Sr, Tl, Mn, Sn, Sb, P, Zn, Mg, Li, Ca, Ga, Ag, Al, Cu, B₂O₃, MoO₃, ZnS, SiO and WO₃.

11. The manufacturing method according to claim 10, further comprising a process of RH grain boundary diffusion at a temperature of 700° C.˜1050° C. after the sintering process.

12. The manufacturing method according to claim 10, wherein the fine powder is put into a coating chamber, the coating chamber is then pumped to be vacuum, the evaporation material is heated to above its evaporation temperature to evaporate the fine powder, the temperature of the coating chamber is in a range of 50° C.˜800° C., the evaporation time is between 6 minutes to 24 hours.
